(19) United States
(12) Patent Application Publication
(10) Pub. No.: US 2006/0257830 A1
(43) Pub. Date: Nov. 16, 2006

(54) Spelling robot

(76) Inventor: Chyi-Yeu Lin, Taipei City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(21) Appl. No.: 11/128,596

(22) Filed: May 13, 2005

(51) Int. Cl. G09B 19/00

(52) U.S. Cl. 434/167

(57) ABSTRACT

A novel interactive educational toy, namely a spelling robot, is provided. The spelling robot mainly contains a command detection unit, an interpretation unit, and an action unit. The command detection unit is the input interface for the spelling robot that accepts the “word” to be spelled. The interpretation unit is the brain of the spelling robot which interprets the “word” command issued to it by the command detection unit. The result of interpretation is directed to the output interface of the spelling robot, the action unit, which actually delivers the spelling. The action unit may also contain a voice unit which actually pronounces the “word.”

### BACKGROUND OF THE INVENTION

1. Field of the Invention

The present invention generally relates to educational devices, and more particularly to a robot for teaching spelling in an interactive manner.

2. The Prior Arts

Spelling is one of the major learning activities for children, especially preschool ones. Parents, however, are not always around or in a helpful mode for their young ones. Prevailing educational means such as spelling books have limited functions and, most of all, offer limited (if any) interaction with the children. Without their parents/teachers around to guide or help them, the children lose their interest in the spelling books quickly. Spelling software running on a computer or some dedicated appliance is a more improved means in terms of interaction with the children. There are usually joyful pictures and music to keep the children focused on the computer screen. However, spelling software is sometimes difficult to operate and usually requires the parent to turn on the computer for the children. In addition, the children are required to sit in front of the screen, which the children might loose their patience after a period of time.

### SUMMARY OF THE INVENTION

Accordingly, the present invention discloses a novel interactive educational toy, namely a spelling robot, which not only teaches children how to spell but also is fun for children to hang around.

The spelling robot mainly contains a command detection unit, an interpretation unit, and an action unit. The command detection unit is the input interface for the spelling robot that accepts the “word” to be spelled. In an embodiment of the present invention, the command detection unit mainly contains a camera (e.g. a CCD camera). When a graphical card having the image of an object (the “word”) is shown to the spelling robot, the image is captured by the camera, interpreted by the interpretation unit, and then spelled by the action unit. In other embodiments, the command detection unit many contain wired or wireless graphic panel or keyboard.

The interpretation unit is the brain of the spelling robot which interprets the “word” command issued to it by the command detection unit. The result of interpretation is then directed to the output interface of the spelling robot, the action unit, which actually delivers the spelling. In an embodiment of the present invention, the action unit contains arms and the arms physically grab a number of letter cubes and align them to form the spelling of the “word.” In other embodiments, the action unit could be a visual display which shows the spelling on the display. The action unit may also contain a voice unit which actually pronounces the “word.”

The spelling robot could be a stationary one or a mobile one which has legs or wheels. The alphabet could be letter cubes (plates, or other geometrical forms) stored inside the spelling robot, piled on the ground, or arranged on a board, etc.

A child's learning process with the spelling robot is more intuitive compared to conventional means. A typical scenario may go like this: a child looks over a pile of graphical cards having various object images on them, picks out the one card whose object image is of the greatest interest to him or her, shows the card to the spelling robot, and the spelling robot spells and optionally pronounces the spelling for the child. A number of children could learn with the spelling robot as well, for example, in a competitive game. A child could pick a graphical card, the rest of the children could compete for the answer, and the spelling robot like a referee spells the correct answer for the children.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic diagram showing a spelling robot according to an embodiment of the present invention.

### DETAILED DESCRIPTION OF THE PREFERRED EMBODIMENTS

The spelling robot according to the present invention is an independent device dedicated to the teaching of spelling. To teach spelling, the spelling robot provides two modes of operations. The first one is the cue-then-answer mode. In this mode, when the spelling robot is presented with a cue (i.e., the word to spell), it then provides an answer (i.e., the correct spelling of the word). The second one is the guess-then-check mode. In this mode, when the robot is presented with a cue and a guess (i.e., a spelling of the word), it then checks if the guess is correct or not and responds accordingly. For the guess-then-check mode, the cue and the guess are not required to be presented to the spelling robot at the same time or in a specific order (e.g., the cue is given first and then the guess). The second mode of operation is especially useful in a parent-guided situation. For example, a parent could pick a cue and ask the child to provide a guess, or a parent could provide a spelling (i.e., a correct guess) and ask the child to search for the corresponding cue. For both modes of operation, the spelling robot would provide the answer or check immediately by default. In some embodiments, the spelling robot requires another trigger to provide the result. This feature gives the child more time to think and correct his or her guess.

The power that drives the spelling robot is taken from either a built-in rechargeable battery or an AC outlet via a power cord. In the latter case, when the spelling robot is not plugged to the AC outlet or there is a black out, the power can be optionally provided from the built-in rechargeable battery. When the spelling robot is turned on by a power switch on the spelling robot, it enters one of the two spelling operation modes immediately.

The spelling robot, despite its name, could become a multi-functional education device if appropriate hardware and/or software module is installed. For example, immediate extensions of the spelling robot are to teach children music or read stories. More details about these extensions will be given later. If the spelling robot has additional functions in addition to the spelling, when it is turned on, the spelling robot enters a predetermined one of the operation modes (it could be one of the two spelling operation modes, an operation mode for learning music, or another operation mode). The spelling robot could be instructed any time later to switch between these operation modes.

There is no specific requirement on the shape and form factor of the spelling robot. Usually the spelling robot has a colorful casing and a joyful outlook so as to be attractive to the children. The spelling robot could be stationary but with a rotatable body. In some embodiments, the spelling robot may even be equipped with legs or wheels so that it could move around in the house, making it more fun to play with.

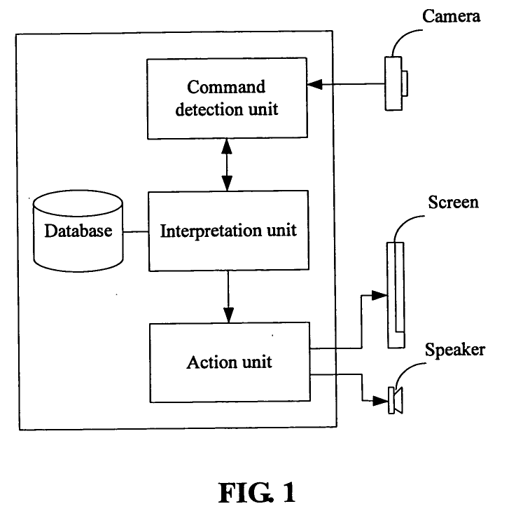

The spelling robot mainly contains a command detection unit, an interpretation unit, and an action unit. The command detection unit, as the input interface to the spelling robot, determines the formats of the cue, guess, and trigger that are recognizable to the spelling robot. In one embodiment, as shown in FIG. 1, the command detection mainly contains a camera (e.g., a CCD camera) mounted on the spelling robot. To cue a spelling robot of this embodiment, there is a deck of predetermined graphical cards each of which has an image of an object, and a child picks a card out of the deck and presents it to the camera. The command detection unit may have an auto-focus function so as to capture a clear picture of the graphical card. The command detection unit may even have a motion detection function and the camera is mounted on a movable head so that the spelling robot can track the hand movement of the child. A trigger to the spelling robot in this embodiment could be implemented as a special graphical card. For the guesses, there is an erasable board on which the child could write down the guess and present it to the camera.

In an alternative embodiment, instead of graphical cards, a set of pre-determined miniature object models are provided. A child picks an object model and presents it to the camera as a cue. For triggers and guesses, this embodiment may still use special graphical cards and erasable board. These are also some embodiments that, besides using graphical cards and miniature object models as cues, a microphone is used for the input of triggers (e.g., specially voice commands) and guesses (e.g., pronouncing the spelling) directly into the microphone.

Conventional means such as a wired or wireless keyboard or keypad could also be used for the input of triggers and/or guesses. There are also embodiments using a wired or wireless graphic panel. On the graphic panel, a set of pre-determined object images are presented and a child could pick one of them as a cue using the finger or a stylus. The graphic panel could also be used for the input of triggers and guesses. Instead of using an erasable board, a child could directly write down the guesses on the graphic panel. As can be seen from the above description, there are actually various combinations of input mechanisms for the command detection unit. For example, a command detection unit of a spelling robot according to the present invention may include a camera, a microphone, and a wired graphic panel. The camera is for using graphical cards as cues. The microphone is for younger children to provide the guesses. The graphical panel is for older children to write down the guesses. Please note that the keyboard or graphic panel is not required to be separate units from the spelling robot. They could actually be mounted on the spelling robot itself.

The captured images, the recorded voices, and the input from the keyboard or graphic panel are delivered to the interpretation unit. The interpretation unit is actually a small computer built into the spelling robot. It is therefore composed of at least a processor, some memory devices, a firmware capable of the pattern recognition, handwriting recognition, and voice recognition so as to decipher the cues, triggers, and guesses. For simplicity sake, the detailed structure of the interpretation unit, as it is just like a scale-down computer, is omitted here. When the spelling robot is turned on, the interpretation unit initializes, besides itself, the command detection unit and the action unit.

Within the interpretation unit, there are one or more databases recording all the possible cues to the spelling robot and the correspond answers to the cues. In some embodiments, the interpretation unit also provides a means for the update or upgrade of its firmware such as via a universal serial bus (USB) port or a memory card slot. There are also some embodiments allowing the databases of the interpretation unit to be expanded or added through the USB port or the memory card slot. In this way, the spelling robot could, on one hand, “grow” with the children and, on the other hand, teaching spelling of languages other than English.

The result of interpretation is then directed to the output interface of the spelling robot, the action unit, which actually delivers the answer or the check result. In some embodiments and in its simplest form of implementation, the action unit is simply a screen mounted on the spelling robot that displays the answer (i.e., the correct spelling) or the check result (i.e., whether the guess is correct). The action unit could also contain a speaker which pronounces the spelling out. In some embodiments, the screen and the graphic panel are actually combined together by a touch-screen. The speaker could also provide some joyful music and voice prompts to add more fun during the operation of the spelling robot.

To add more fun into the learning process, some embodiments prepare a set of letter cubes which contains multiple sets of the alphabetical letters. When asked to spell the answer by the interpretation unit, the action unit finds all the letters that constitute the spelling and uses its arm (or arms or other means) to align the letter cubes horizontally or vertically. For example, when the spelling robot is presented with a car's image to its command detection unit in a cue-then-answer mode, the action unit finds the three letter cubes “C,” “A,” “R,” and aligns them. In the mean time, the speaker (if present) would also spell the answer out.

Please note that the letter cubes could be scattered on the floor and the spelling robot stacks or arranges them on the floor. If the spelling robot is mobile (with legs or wheels), it could also “walk or move” to the pile of letter cubes and, after “spelling” the answer, returns to the child. Similarly, the letter cubes could also be scattered on a table top, and the spelling stacks or arranges them on the table top. There are also some embodiments that, instead of using letter cubes, provide a set of pre-determined letter plates on a specially designed board. The spelling could find the letter places that constitute the answer and arrange them on the board. There are also embodiments that the letter cubes or plates are taken out of a pocket or some storage space of the spelling robot. Please note that the letters are not necessarily in the form of cubes or plates. Other geometrical forms are also possible. There are some embodiments that the spelling robot writes down the answer on a special board. A child could erase the board after the spelling robot has finished writing. There are also some embodiments that the spelling robot projects the answer on the wall.

Based on the foregoing description, it is clear that, despite the various embodiments of the present invention, the most significant characteristic of the spelling robot lies in its accepting a cue (and a guess) and then responding with a result. Based on such an interactive means, the spelling robot could be expanded to conduct a number of teaching activities other than spelling without modifying its hardware or software structure. For example, the spelling robot could teach music in a scenario like the following. The child presents to the spelling robot a graphical card having the image of a music instrument (or a music note), the spelling robot responds by playing a piece of music generated by the music instrument (or a tone represented by the music note). Similarly, the spelling robot could read a story after the child presents to the spelling robot a “story” card. For these expanded functions, all that is required is to have an appropriate database installed inside the interpretation unit of the spelling robot. The database records all possible cues and their corresponding answers.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A robot comprising:
a command detection unit having an input interface for receiving a cue from a user, said command detection unit delivering said cue in an appropriate format to an interpretation unit;
an interpretation unit deciphering said cue and determining a corresponding answer to said cue, said interpretation unit delivering said answer to an action unit; and
an action unit delivering said answer to said user in an appropriate format.

2. The robot according to claim 1, wherein said answer is delivered after said robot receives a trigger.

3. The robot according to claim 1, wherein said input interface is a camera and said cue is selected from a plurality of pre-determined graphical cards, each having a pre-determined image.

4. The robot according to claim 1, wherein said input interface is a camera and said cue is selected from a plurality of pre-determined object models.

5. The robot according to claim 2, wherein said input interface is a camera and said trigger is selected from a plurality of pre-determined graphical cards, each having a pre-determined image.

6. The robot according to claim 2, wherein said input interface is a microphone and said trigger is a voice segment generated by said user into said microphone according to a pre-determined vocabulary.

7. The robot according to claim 2, wherein said input interface is a keyboard and said trigger is a text string typed by said user according to a pre-determined vocabulary.

8. The robot according to claim 2, wherein said input interface is a graphic panel and said trigger is a command issued by said user from said graphic panel according to a pre-determined vocabulary.

9. The robot according to claim 1, wherein said input interface is a graphic panel and said cue is a command issued by said user from said graphic panel according to a pre-determined vocabulary.

10. The robot according to claim 1, wherein said interpretation unit comprises a database recording all possible cues and their corresponding answers.

11. The robot according to claim 1, wherein said robot has an interface for update and upgrade.

12. The robot according to claim 1, wherein said answer is delivered to said user by displaying on a screen.

13. The robot according to claim 1, wherein said answer is delivered to said user by a speaker.

14. The robot according to claim 1, wherein said answer is delivered to said user by said robot arranging a plurality of objects selected from a set of pre-determined objects.

15. The robot according to claim 1, wherein said answer is delivered to said user by said robot writing said answer down.

16. A robot comprising:
a command detection unit having an input interface for receiving a cue and a guess from a user, said command detection unit delivering said cue and said guess in an appropriate format to an interpretation unit;
an interpretation unit deciphering said cue and said guess and determining a corresponding answer by comparing said cue to said guess, said interpretation unit delivering said answer to an action unit; and
an action unit delivering said answer to said user in an appropriate format.

17. The robot according to claim 16, wherein said answer is delivered after said robot receives a trigger.

18. The robot according to claim 16, wherein said input interface is a camera and said cue is selected from a plurality of pre-determined graphical cards, each having a pre-determined image.

19. The robot according to claim 16, wherein said input interface is a camera and said cue is selected from a plurality of pre-determined object models.

20. The robot according to claim 17, wherein said input interface is a camera and said trigger is selected from a plurality of pre-determined graphical cards, each having a pre-determined image.

21. The robot according to claim 17, wherein said input interface is a microphone and said trigger is a voice segment generated by said user into said microphone according to a pre-determined vocabulary.

22. The robot according to claim 17, wherein said input interface is a keyboard and said trigger is a text string typed by said user according to a pre-determined vocabulary.

23. The robot according to claim 17, wherein said input interface is a graphic panel and said trigger is a command issued by said user from said graphic panel according to a pre-determined vocabulary.

24. The robot according to claim 16, wherein said input interface is a graphic panel and said cue is a command issued by said user from said graphic panel according to a pre-determined vocabulary.

25. The robot according to claim 16, wherein said interpretation unit comprises a database recording all possible cues and their corresponding correct guesses.

26. The robot according to claim 16, wherein said robot has an interface for update and upgrade.

27. The robot according to claim 16, wherein said answer is delivered to said user by displaying on a screen.

28. The robot according to claim 16, wherein said answer is delivered to said user by a speaker.

29. The robot according to claim 16, wherein said answer is delivered to said user by said robot arranging a plurality of objects selected from a set of pre-determined objects.

30. The robot according to claim 16, wherein said answer is delivered to said user by said robot writing said answer down.

31. The robot according to claim 16, wherein said input interface is an erasable board and said guess is generated by said user through writing on said erasable board.

32. The robot according to claim 16, wherein said input interface is a microphone and said guess is a voice segment generated by said user into said microphone according to a pre-determined vocabulary.

33. The robot according to claim 16, wherein said input interface is a keyboard and said guess is a text string typed by said user.

34. The robot according to claim 16, wherein said input interface is a graphic panel and said guess is generated by said user through writing on said graphic panel.
